(19) United States
(12) Patent Application Publication
(10) Pub. No.: US 2016/0012014 A1
(43) Pub. Date: Jan. 14, 2016

(54) KEY CONTROL ASSESSMENT TOOL

(71) Applicant: BANK OF AMERICA CORPORATION, CHARLOTTE, NC (US)

(72) Inventors: John S. Mihm, Charlotte, NC (US); Emily W. Shonts, Charlotte, NC (US); Michael T. Breen, Charlotte, NC (US); Athina P. Croom, Columbia, SC (US)

(21) Appl. No.: 14/325,536

(22) Filed: Jul. 8, 2014

(51) Int. Cl. G06F 17/18

(52) U.S. Cl. CPC G06F 17/18

(57) ABSTRACT

An apparatus and/or method for configuring a computer to execute a method for determining whether an entity process exceeds a threshold is provided. The exceeding of said threshold may characterize the process as a high risk process. The method may include using a receiver to receive selected effectiveness criteria. The selection of effectiveness criteria may be based on the identification of the entity process. The method may further include determining an index value for each of the effectiveness criteria with respect to the entity process; weighting the index value for each of the effectiveness criteria; calculating a composite weighted risk score for the entity process based on the weighting of the index value for each of the effectiveness criteria; and comparing the composite weighted risk score to the threshold in order to determine whether the entity process is a high risk process.

### FIELD OF TECHNOLOGY

The disclosure relates to tools for determining whether an entity process should be categorized as a high risk process or not. The disclosure further relates to determining, when the process has been categorized as a high risk process, whether entity controls are in place that adequately address the risk of the process.

### BACKGROUND OF THE DISCLOSURE

Risk, and controls associated therewith, is a well-studied topic. Yet much of the literature associated with entity risk and risk controls discusses risk assessment and not necessarily control effectiveness.

In fact, little, if any, of the literature has addressed whether already existent controls are aligned with risks that the controls are intended to mitigate.

Furthermore, the literature has not typically addressed the risk controls according to a standardized set of criteria. As such, the literature, and the conventional processes and methods, are deficient with respect to analysis of risk controls.

It would be desirable to provide a control assessment tool for identifying whether or not a control is aligned to the risks of the process to which the control is directed.

It would also be desirable to provide systems and methods for determining whether a control is preferably objectively relatively strong or weak relative to a preferably selected plurality of control criteria.

### SUMMARY OF THE DISCLOSURE

Systems and methods for configuring a computer to execute a method for determining a degree of alignment between a control element vector and a pre-determined risk factor are provided. The control element vector and the pre-determined risk factor may typically be associated with an entity process. The method may include using a receiver to receive the control element vector, using the receiver to receive the pre-determined risk factor; and using a processor to determine a degree of alignment between the control element vector and the pre-determined risk factor. The processor may further be configured to receive a set of control attributes associated with the control element vector. The processor may be yet further configured to receive scores of the attributes. The processor may be still further configured to perform a weighting algorithm on each attribute, such that the algorithm outputs a weighted composite score associated with each of the plurality of control element vectors based, at least in part, on the scores of each of the attributes.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows illustrative apparatus in accordance with the principles of the invention;

FIG. 2 shows another illustrative apparatus in accordance with the principles of the invention;

FIGS. 3A-3Q show an illustrative spreadsheet for use with embodiments;

FIGS. 4A-4C show illustrative diagrams of strong and weak control criteria as well as various processes according to certain embodiments; and

FIGS. 5A-5F show another illustrative spreadsheet for use with certain embodiments.

### DETAILED DESCRIPTION OF THE DISCLOSURE

Systems and methods may include configuring a computer to execute a method for determining whether an entity process exceeds a threshold. Exceeding the threshold may cause a process to be characterized as a high risk process.

The method may include receiving plurality of selected effectiveness criteria. A selection of the effectiveness criteria may be based, at least in part, on the identification of the entity process.

The method may include determining an index value for each of the effectiveness criteria with respect to the entity control. The method may further include weighting the index value for each of the effectiveness criteria and calculating a composite weighted risk score. The composite risk score for the entity process may be calculated based on the weighting of the index value for each of the effectiveness criteria. The process may further compare the composite weighted risk score to the threshold in order to determine whether the entity process is a high risk process.

In certain embodiments, the selected effectiveness criteria may include one or more criteria from a group of criteria. The selected risk criteria may include at least two criteria selected from a group of criteria. The group of criteria may include one or more of the following: whether a high level of technical complexity is associated with the process; does this process handle non-public customer information; does this process heavily rely on third party suppliers/vendors to execute a majority of the process; are extensive changes associated with the process implemented over a pre-determined time period; are unstable or volatile conditions associated with the process predicted to occur within a pre-determined time period; do one or more high risk laws, rules and/or regulations at the Federal and/or state level apply to the process; is a relatively high probability of operational loss associated with implementation of the process; is a significant interest/awareness resulting in relatively high frequency of regulatory examinations associated with the process; does the process require specialized skills; does the process potentially impact customer experience or cause dissatisfaction; and does the process have a high potential to significantly impact reputation of the entity.

Systems and methods according to the invention may receive scores of attributes associated with the selected effectiveness criteria.

A set of control vectors associated with the process may include at least three (or any other suitable number) of the following control vectors: the control vector conveys a clear understanding of the risk to which the control vector is directed; the control vector is preventative; the control vector is corrective; the control vector is automated; failure of the control vector causes a direct consequence; the control vector output is testable; a demonstrable linkage exists between the control vector and risk reduction; the control vector can be bypassed; and a set of metrics may be implemented that properly reflects the performance of the control vector.

A degree of alignment between each of the plurality of effectiveness criteria and a control element vector may also be determined. The control element vector and each of the pre-determined effectiveness criteria may be associated with the entity process.

The degree of alignment may be binary. The degree of alignment may be selected from the group consisting of aligned and not aligned.

Systems and methods for determining a degree of alignment between a control element vector and a pre-determined risk factor are also provided. The control element vector and the pre-determined risk factor may both be associated with an entity process.

The systems and methods may include receiving the control element vector and the pre-determined risk factor. The method may further include determining a degree of alignment between the control element vector and the pre-determined risk factor. The determination may be based on one or more algorithms.

The systems and methods may further include receiving a set of control attributes associated with the control element vector and receiving scores of the attributes. The systems and methods may also include perform a weighting algorithm on each attribute, such that the algorithm outputs a weighted composite score associated with each of the plurality of control element vectors based, at least in part, on the scores of each of the attributes.

The set of attributes may include at least two (or other suitable number) of the following attributes: the control vector conveys a clear understanding of the risk to which the control vector is directed; the control vector is preventative; the control vector is corrective; the control vector is automated; failure of the control vector comprises a consequence; the control vector output is testable; a demonstrable linkage exists between the control vector and risk reduction; the control vector can be bypassed; and a set of metrics may be implemented that properly reflects the performance of the control vector.

The pre-determined risk factor may be selected from a group consisting of high level of technical complexity associated with the process; handling, by the entity, of non-public customer information; heavy reliance on third party suppliers/vendors to execute a majority of the process; extensive changes associated with the process implemented over a pre-determined time period; unstable or volatile conditions predicted within a pre-determined time period; one or more high risk laws, rules and/or regulations at the Federal and/or state level apply to the process; relatively high probability of operational loss; significant interest/awareness resulting in relatively high frequency of regulatory examinations; relatively high probability of significant operational loss; requires specialized skills; high potential to impact customer experience or to cause dissatisfaction; and high potential to significantly impact reputation.

Certain embodiments may include receiving a plurality of the selected risk factors. The selection of risk factors may be based, at least in part, on the identification of the process.

Some embodiments may include determining an index value for each of the risk factors with respect to the process and weighting the index value determined for each of the risk factors.

Systems and methods may include calculating a composite weighted risk score for the entity process based on the weighting of the index value for each of the risk factors.

Systems and methods may include comparing the composite weighted risk score to a pre-determined threshold in order to determine whether the process is a high risk process.

Illustrative embodiments of apparatus and methods in accordance with the principles of the invention will now be described with reference to the accompanying drawings, which form a part hereof It is to be understood that other embodiments may be utilized and structural, functional and procedural modifications may be made without departing from the scope and spirit of the present invention.

As will be appreciated by one of skill in the art upon reading the following disclosure, the embodiments may be embodied as a method, a data processing system, or a computer program product. Accordingly, the embodiments may take the form of an entirely hardware embodiment, an entirely software embodiment or an embodiment combining software and hardware aspects.

Furthermore, embodiments may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

Exemplary embodiments may be embodied at least partially in hardware and include one or more databases, receivers, transmitters, processors, modules including hardware and/or any other suitable hardware. Furthermore, operations executed may be performed by the one or more databases, receivers, transmitters, processors and/or modules including hardware.

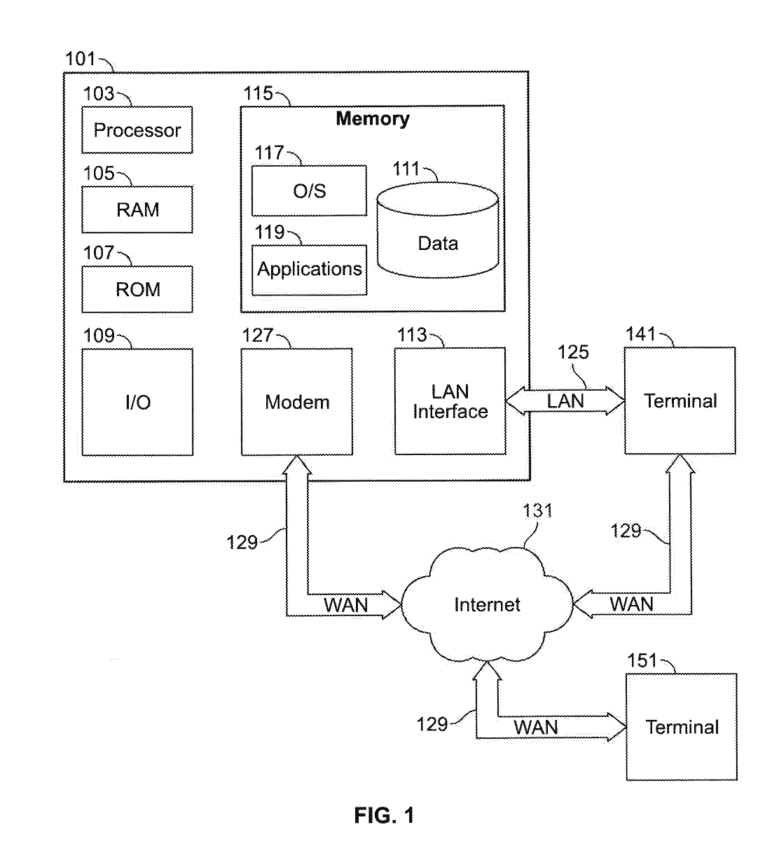

FIG. 1 is a block diagram that illustrates a generic computing device 101 (alternately referred to herein as a “server”) that may be used according to an illustrative embodiment of the invention. The computer server 101 may have a processor 103 for controlling overall operation of the server and its associated components, including RAM 105, ROM 107, input/output module 109, and memory 115.

Input/output (“I/O”) module 109 may include a microphone, keypad, touch screen, and/or stylus through which a user of server 101 may provide input, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by server 101, such as an operating system 117, application programs 119, and an associated database 111. Alternately, some or all of server 101 computer executable instructions may be embodied in hardware or firmware (not shown). As described in detail below, database 111 may provide storage for transferring information input into one or more of the database(s) described herein, as well as line of business information, process information, control element vector information, algorithmic information for alignment determination of control element vector(s) with respect to ranking tool(s), etc.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 113. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages via the World Wide Web from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

A terminal such as 141 or 151 may be used by a user of the embodiments set forth herein. Information input may be stored in memory 115. The input information may be processed by an application such as one of applications 119.

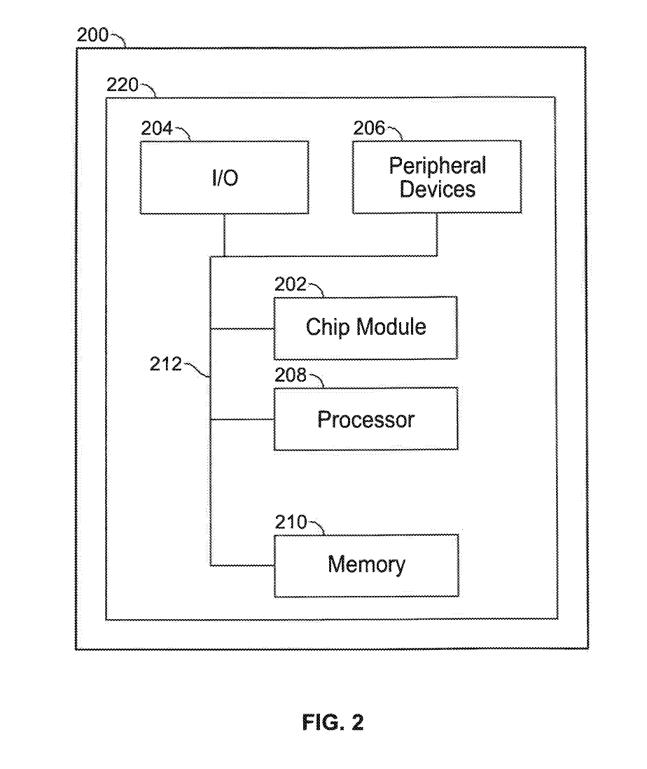

FIG. 2 shows an illustrative apparatus that may be configured in accordance with the principles of the invention.

FIG. 2 shows illustrative apparatus 200. Apparatus 200 may be a computing machine. Apparatus 200 may be included in apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include the transmitter device and the receiver device and may interface with fiber optic cable, coaxial cable, telephone lines, wireless devices, PHY layer hardware, a keypad/display control device or any other suitable encoded media or devices; peripheral devices 206, which may include counter timers, real-time timers, power-on reset generators or any other suitable peripheral devices; logical processing device (“processor”) 208, which may compute data structural information, structural parameters of the data, quantify indices; and machine-readable memory 210.

Machine-readable memory 210 may be configured to store in machine-readable data structures: data lineage information; data lineage, technical data elements; data elements; business elements; identifiers; associations; relationships; and any other suitable information or data structures.

Components 202, 204, 206, 208 and 210 may be coupled together by a system bus or other interconnections 212 and may be present on one or more circuit boards such as 220. In some embodiments, the components may be integrated into a single silicon-based chip.

Apparatus 200 may operate in a networked environment supporting connections to one or more remote computers via a local area network (LAN), a wide area network (WAN), or other suitable networks. When used in a LAN networking environment, apparatus 200 may be connected to the LAN through a network interface or adapter in I/O circuitry 204. When used in a WAN networking environment, apparatus 200 may include a modem or other means for establishing communications over the WAN. It will be appreciated that the network connections shown are illustrative and other means of establishing a communications link between the computers may be used. The existence of any of various well-known protocols such as TCP/IP, Ethernet, FTP, HTTP and the like is presumed, and the system may be operated in a client-server configuration to permit a user to operate processor 208, for example over the Internet.

Apparatus 200 may be included in numerous general purpose or special purpose computing system environments or configurations. Examples of well-known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, tablets, programmable consumer electronics, network PCs, minicomputers, mainframe computers, distributed computing environments that include any of the above systems or devices, and the like.

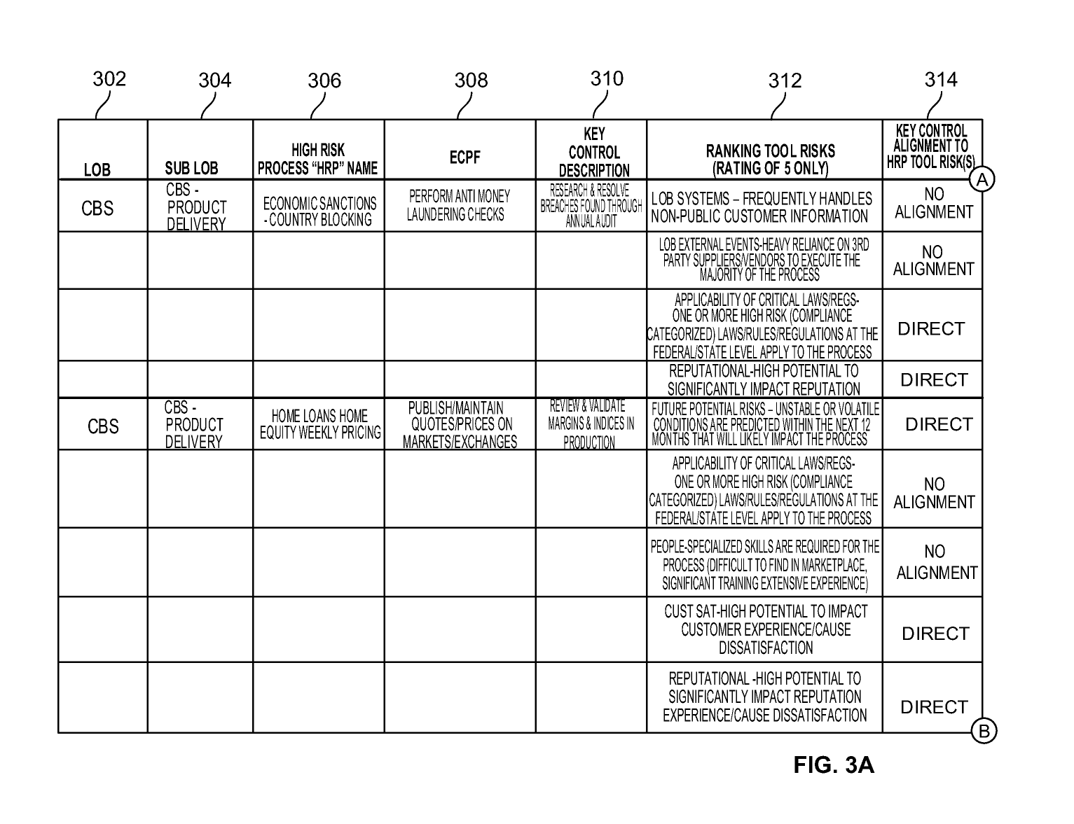

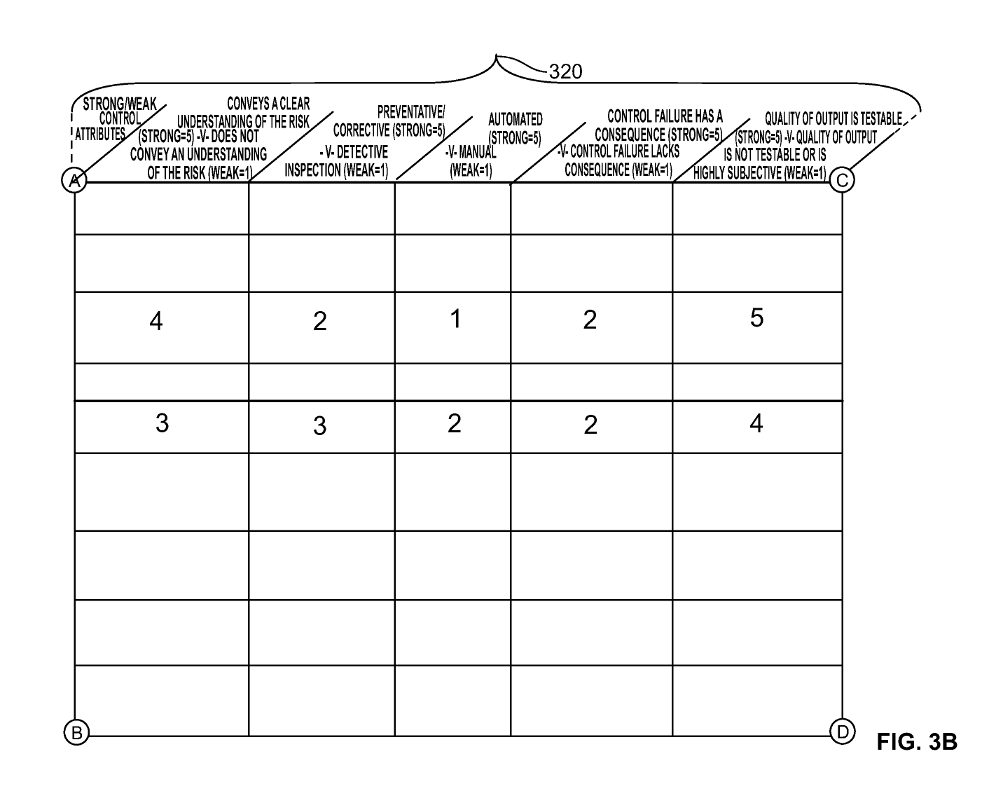

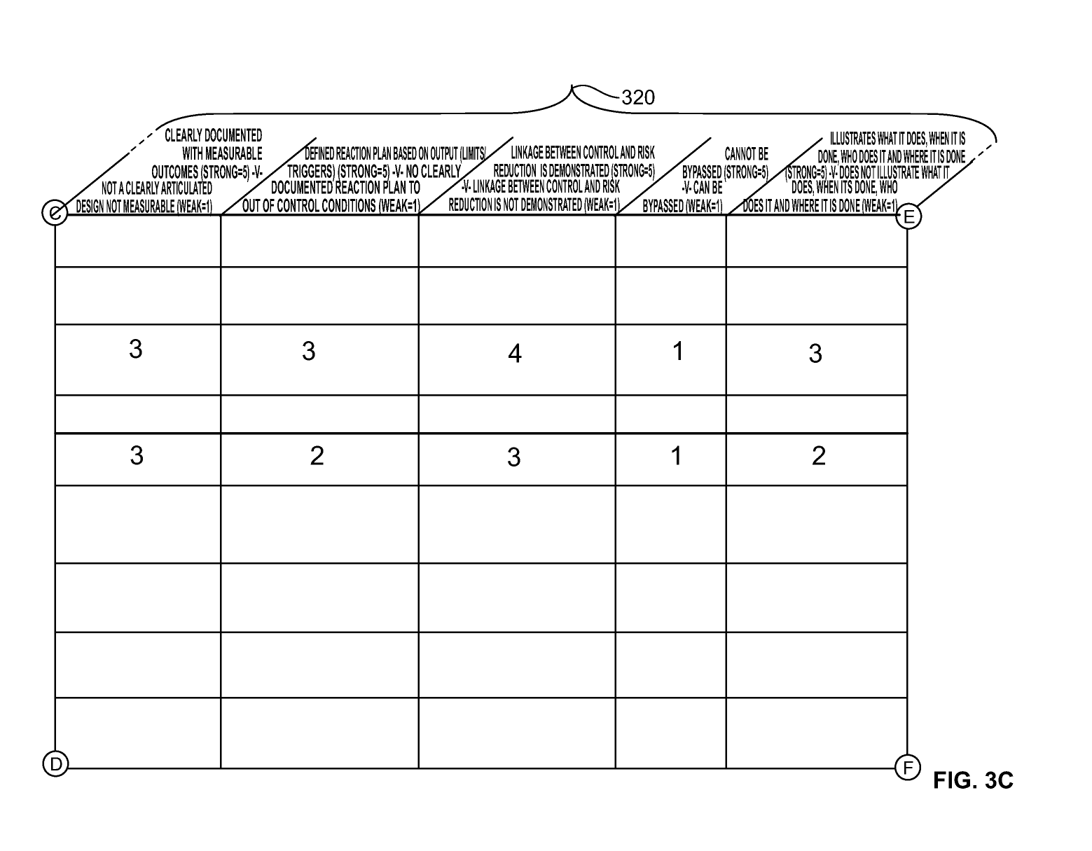

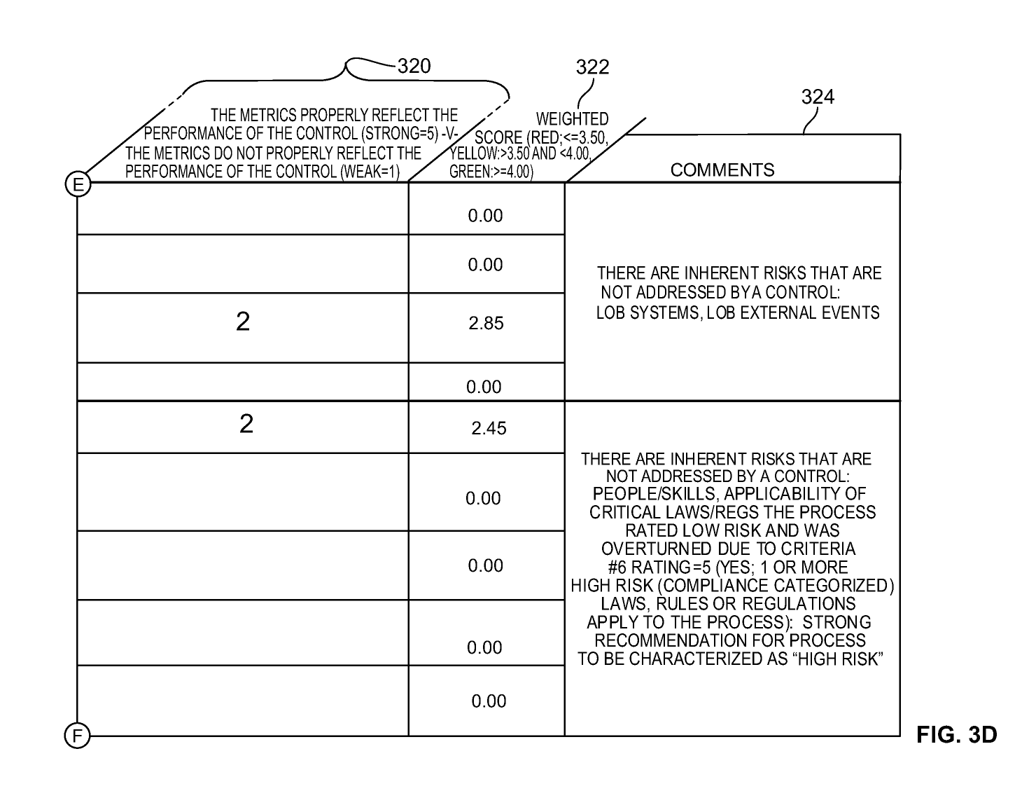

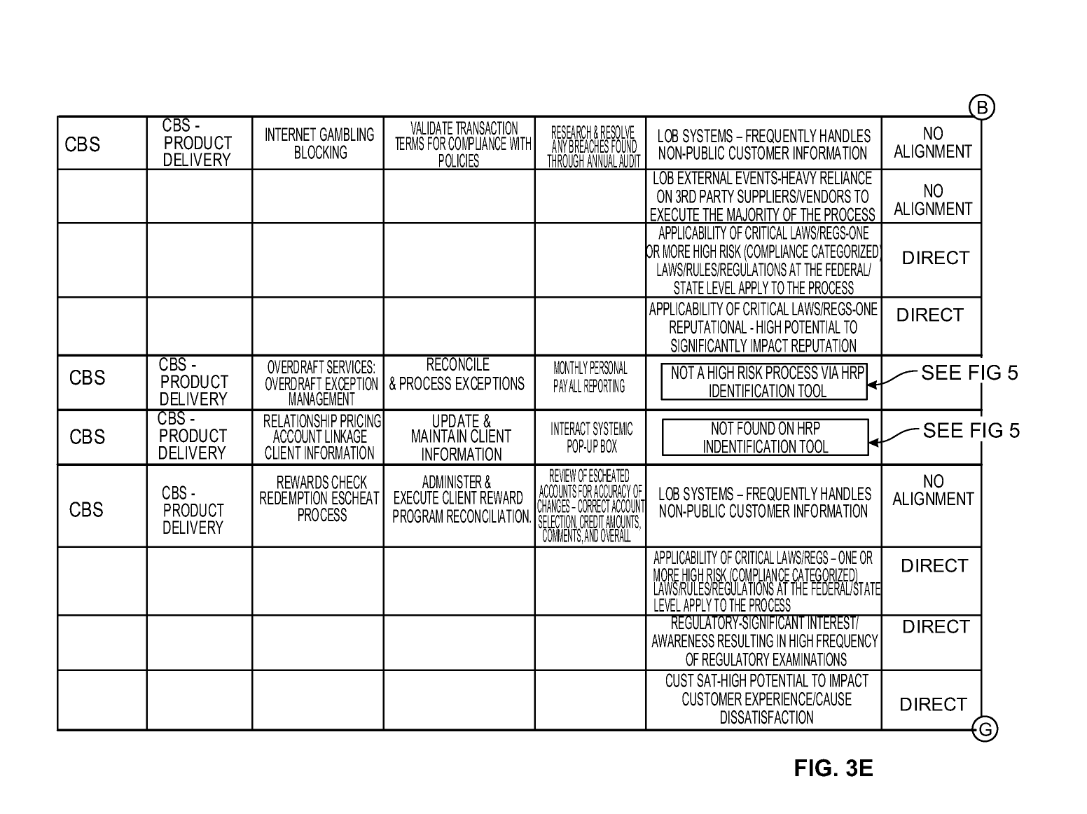

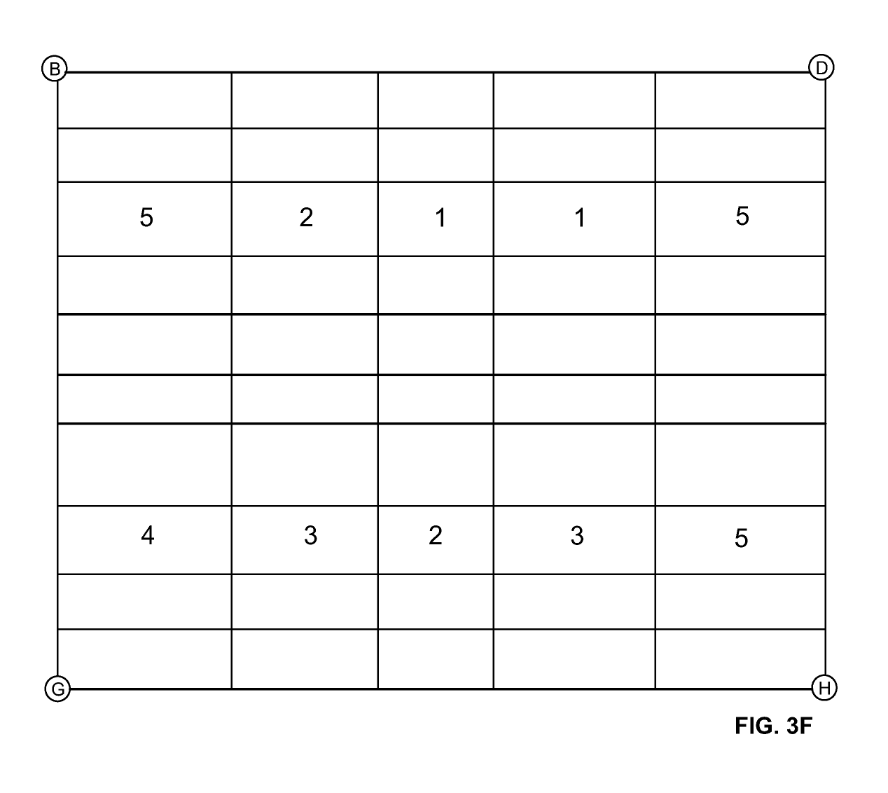

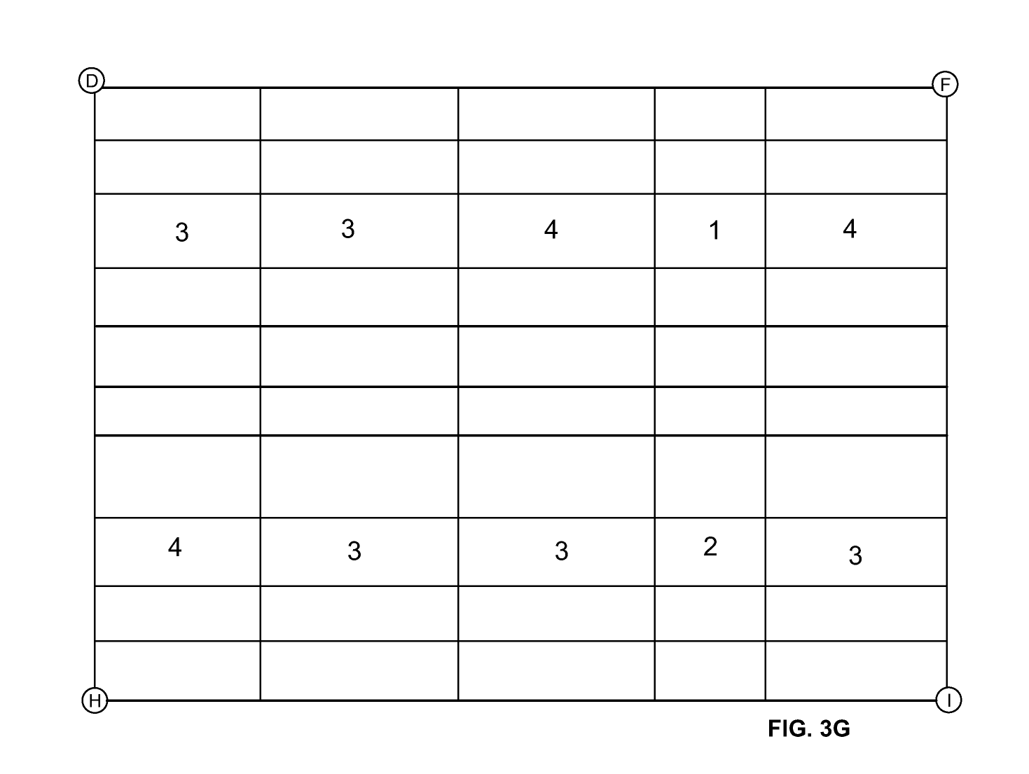

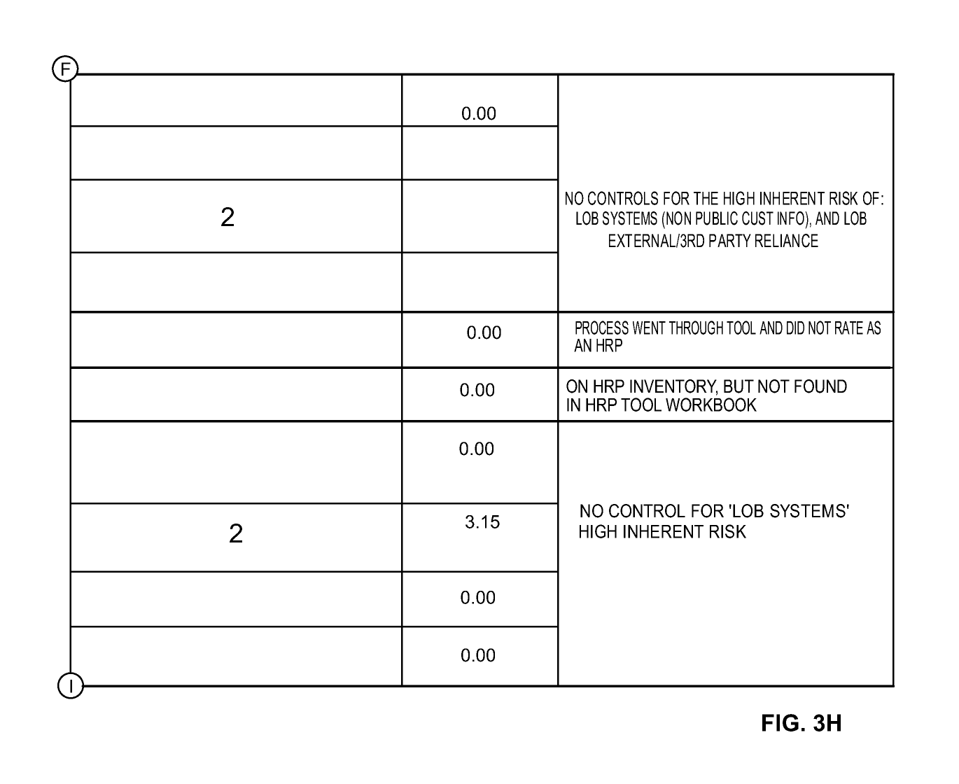

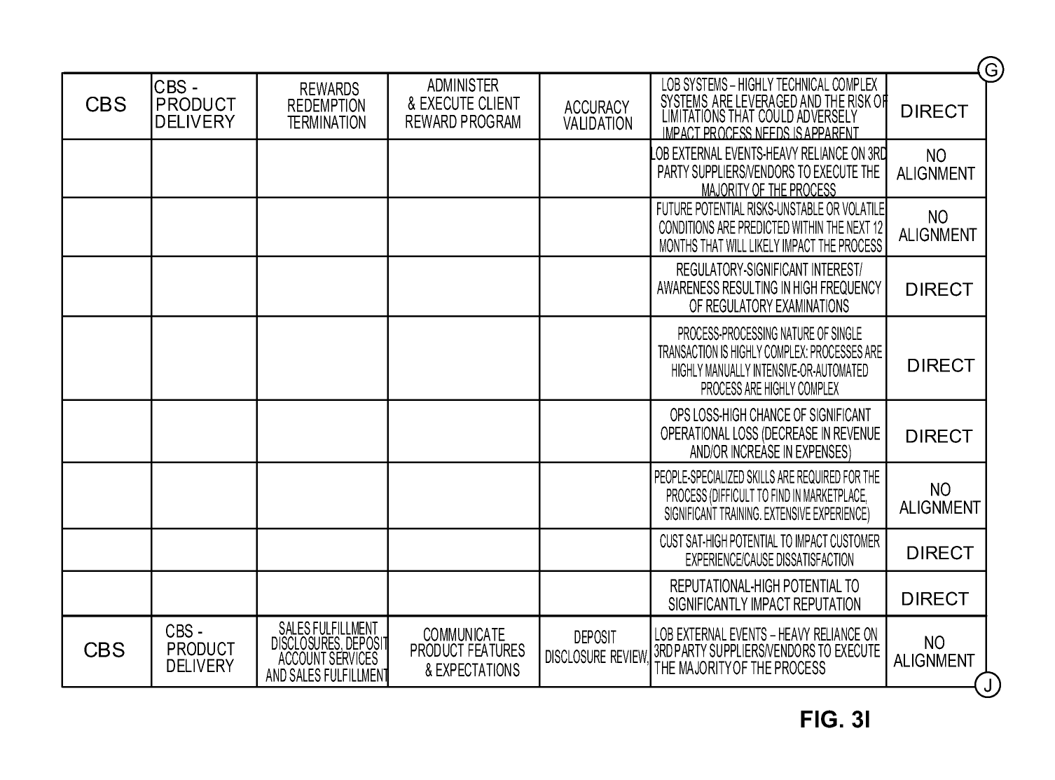

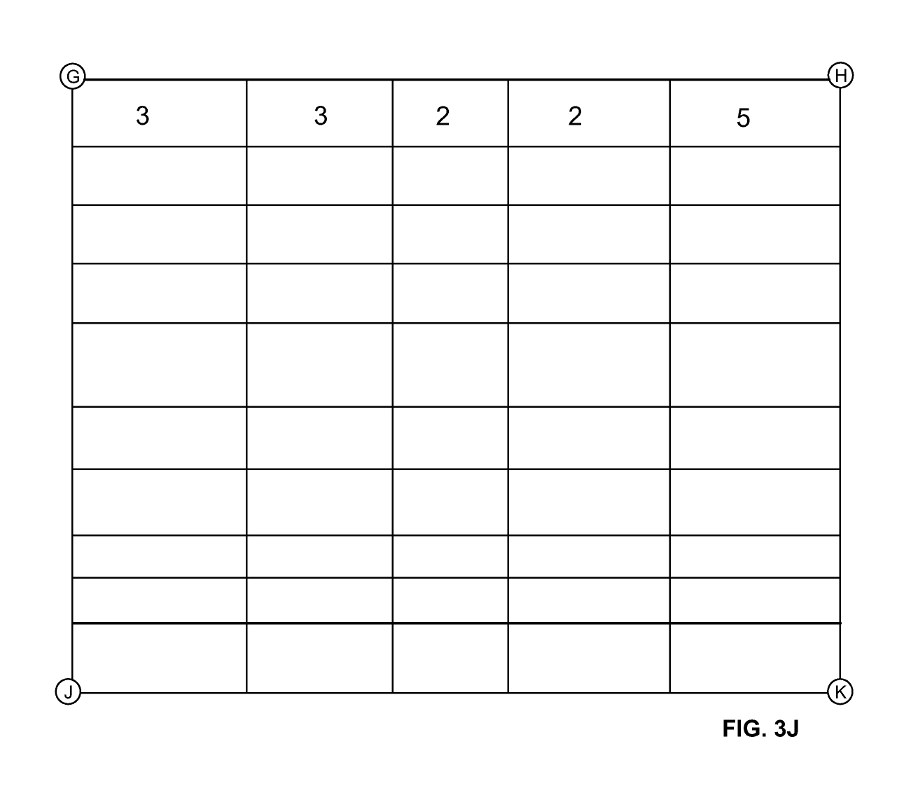

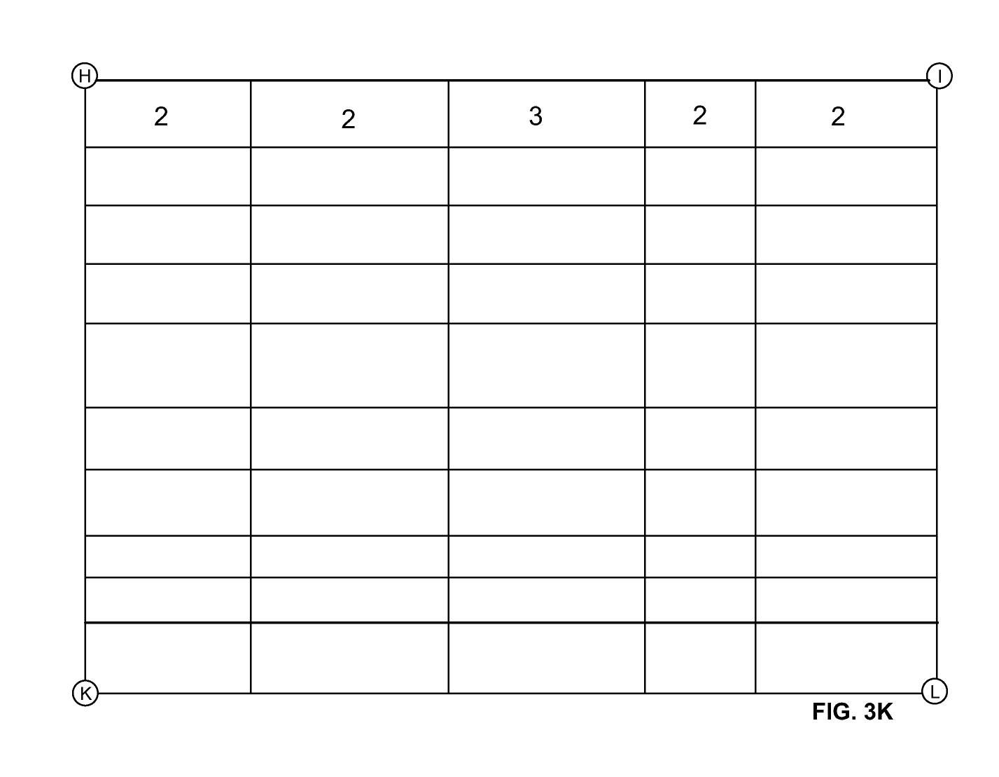

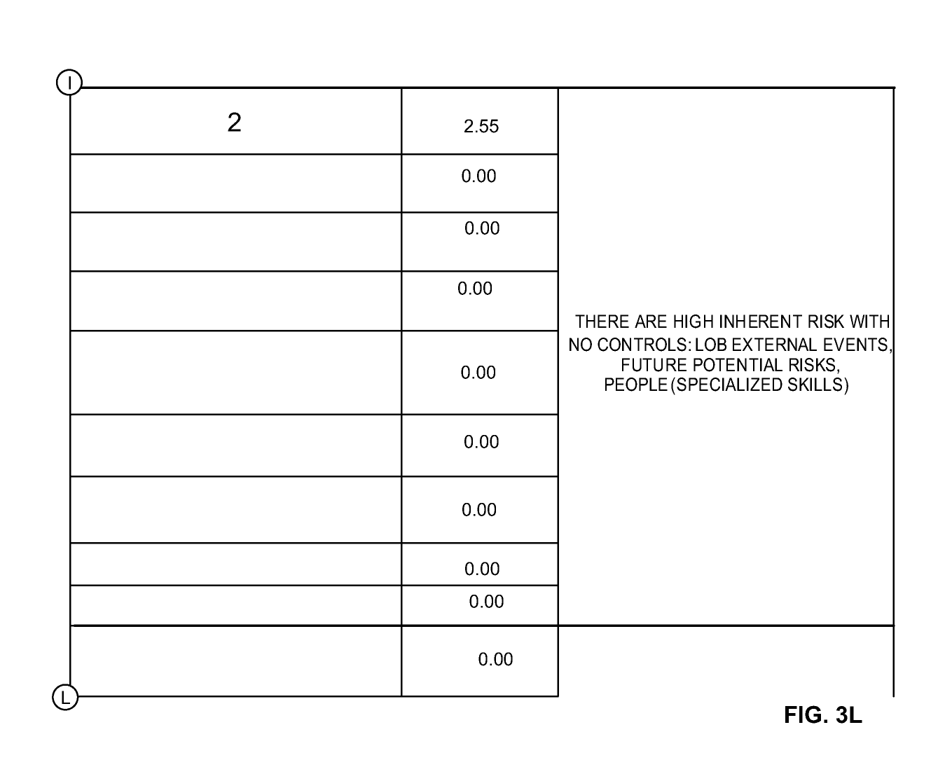

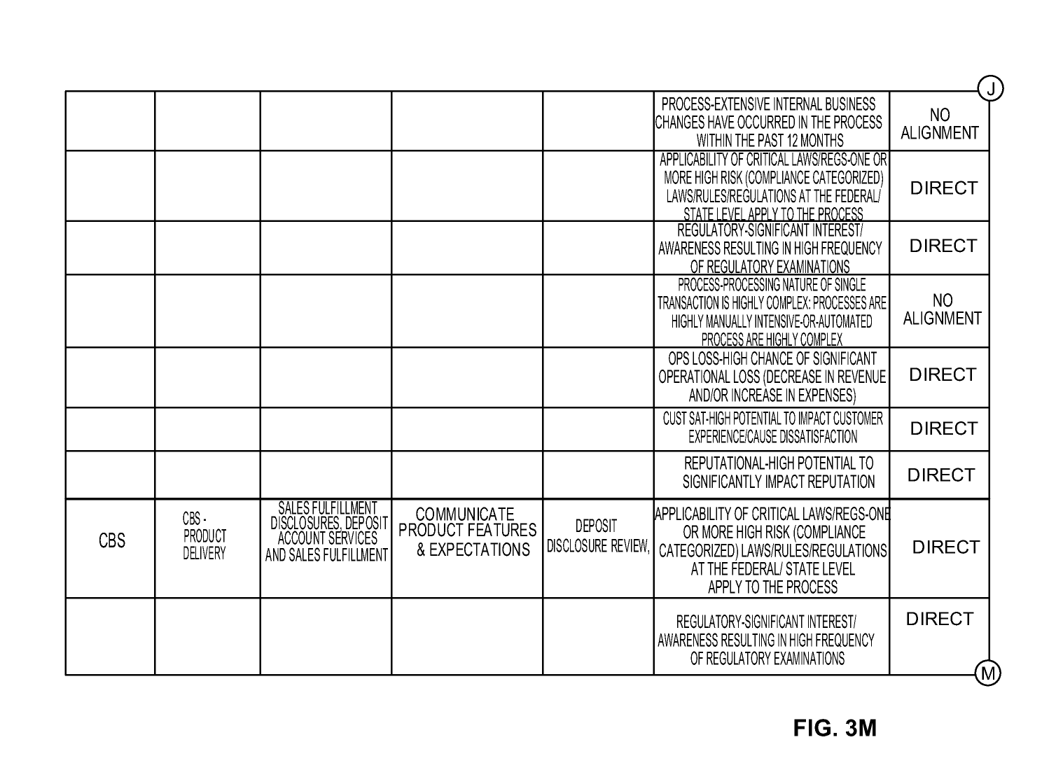

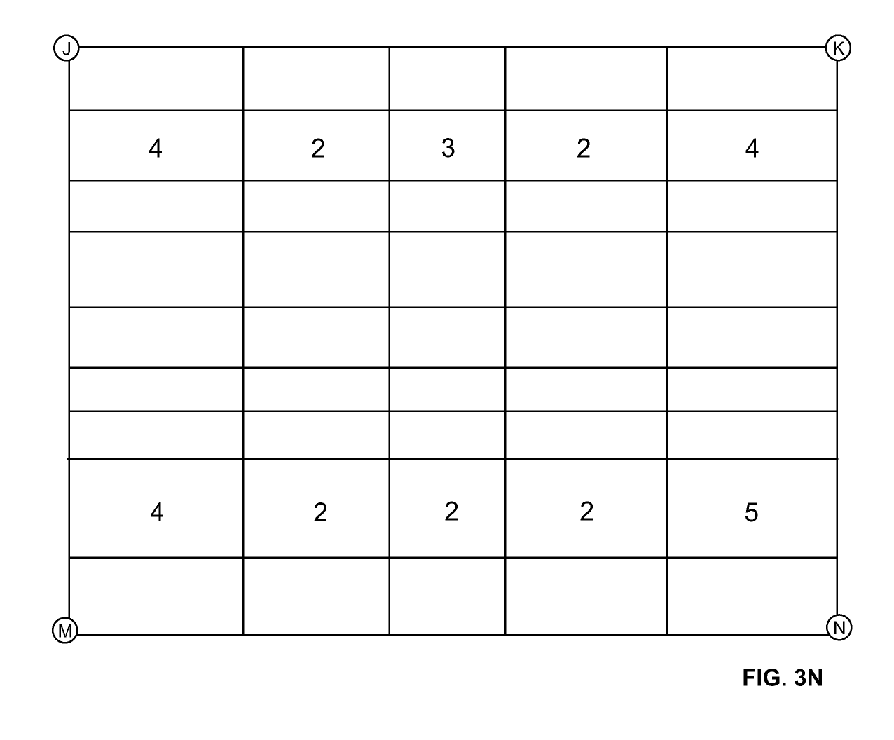

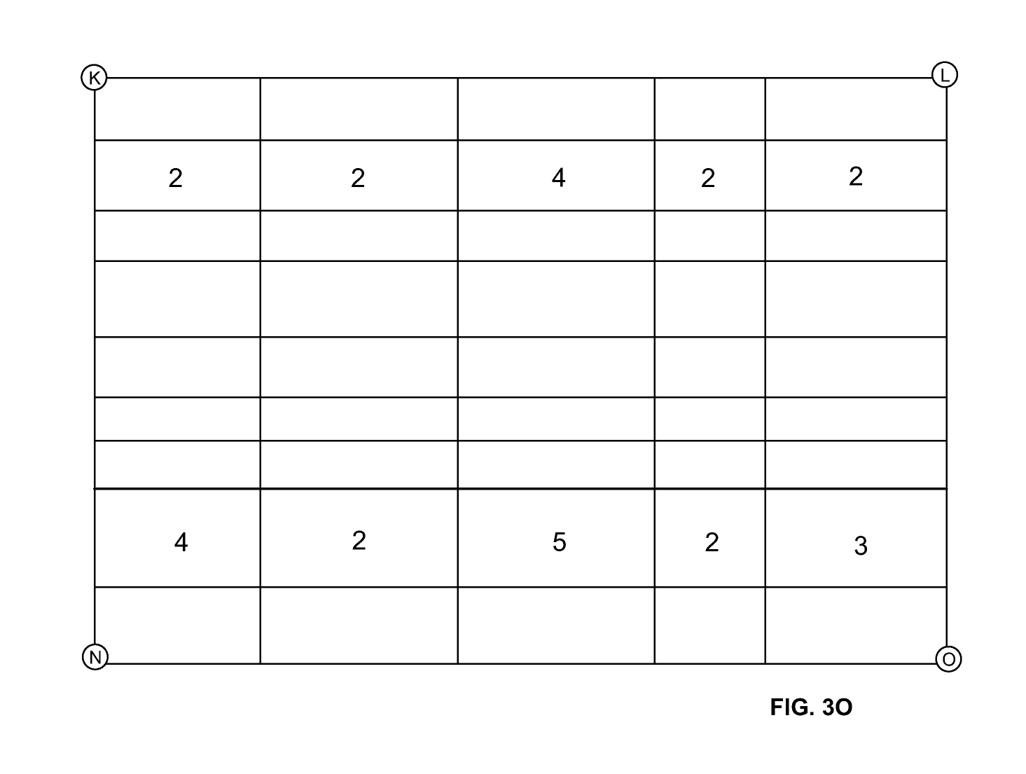

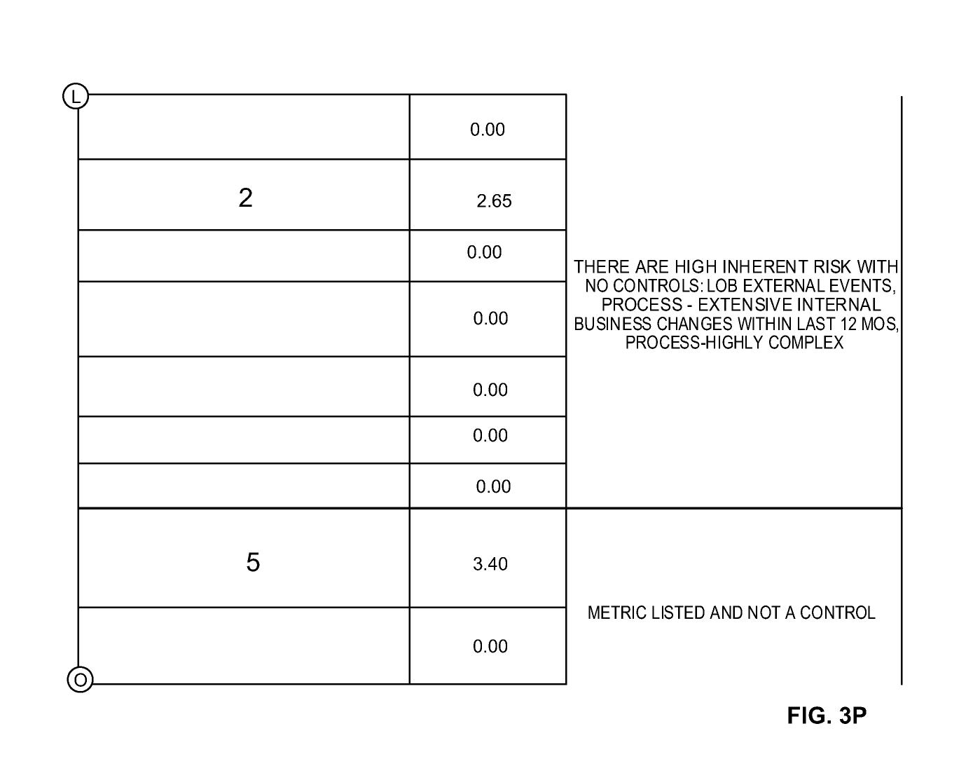

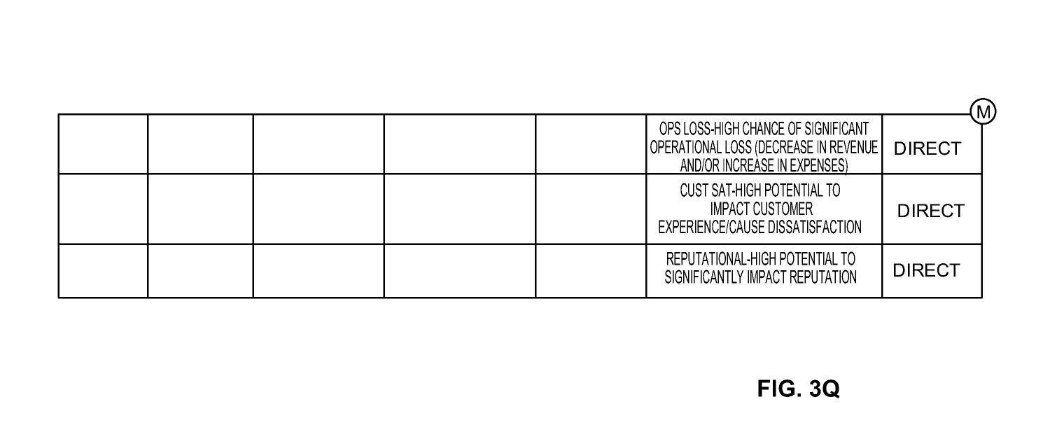

FIGS. 3A-3Q shows a spreadsheet for defining the relationship of certain risks and associated risk controls. FIG. 3 shows, in a first column 302, a line of business (“LOB”) entry (consumer banking services (“CBS”). The LOB is preferably associated with the high risk process (“HRP”). A second column 304, shows a sub-LOB, CBS product delivery, which is also preferably associated with the HRP.

Column 306 preferably identifies the HRP that is being evaluated. Such an evaluation may include a determination of the degree of alignment of the HRP with various risks associated with the LOB, shown in column 312. In some embodiments of the invention, only risks that correspond to a score, such as five out of five—indicating the highest relative risk, may be used in determining whether adequate controls are in place to offset, or even temper, the selected risk. FIG. 3E shows a number of HRPs—i.e., overdraft exception management and relationship pricing account linkage client information—that do not exhibit sufficient risk for inclusion into the spreadsheet 300 as an HRP. Such an HRP is not further evaluated for adequacy of risk control.

Such an evaluation may obtain a binary output, such as “no alignment” or “direct alignment” as shown in column 314. In certain embodiments, the alignment of the key control to the HRP may be expressed as an integer, for example an integer between 1-10 where 10 is completely aligned and 1 is not aligned. In certain embodiments, the alignment of the key control to the HRP may be expressed as a degree, for example a degree between 0 degrees and 90 degrees where 0 degrees is completely aligned and 90 degrees is orthogonal thereto.

Column 310 shows an exemplary description of a control. In one example, the top cell shown in column 310 shows that the performance of economic sanctions may be characterized as researching and resolving breaches found through an annual audit or other suitable review process.

The foregoing has described one exemplary embodiment of an aspect of the spreadsheet shown in FIGS. 3A-3Q. It should be noted that the other entries in FIG. 3—e.g., HRP “home loans/home equity weekly pricing”, inter alia, may be understood to operate similarly to the economic sanctions/country blocking HRP described above.

It should be noted further that the alignment shown in column 314 may be derived and/or determined by any one of a number of machine-learning algorithms.

Columns 320 shows exemplary factors related to whether the control is a weak or strong control. For example, the numbers that are filled in on the third row of columns 320 correspond to the entry in FIG. 3A “applicability of critical laws/regulations—one or more high risk (compliance categorized) laws/rules/regulations at the Federal/State level apply to the process.” Thus, the numbers that are filled in on the third row of columns 320 indicate whether performing AML checks and other actions that research and resolve breaches found through an annual audit address the risks associated with the HRP when critical laws/regulations apply to the HRP.

Exemplary columns 320 include exemplary control attributes. Such attributes may include whether the control conveys a clear understanding of the risk, whether the control is preventative/corrective or detective of a risk issue that may be detected during an inspection, whether the control is automated or manual, whether the failure of a control is directly associated with a consequence, whether the quality of output is testable (objective) or not (subjective), whether the control can be clearly documented with measurable outcomes or not a clearly articulated design that presents non-measurable outcomes, whether a defined reaction plan based on output limits/triggers exists or no defined reaction plan exists, whether there a linkage between control and risk reduction is demonstrated by empirical evidence or not, whether the control can be bypassed or not, whether the control illustrates what it does, when it is done, who performs it and where it is done, and whether the metrics associated with the control properly reflect the performance of the control. It should be noted that the foregoing list is merely exemplary and any suitable attribute may be implemented to determine the relative strength of a control.

As shown at the top of columns 320, each of the control attributes may be scored at a metric between 1 and 5 or according to any suitable metric. Such metrics may be weighted and then combined and/or normalized to form a score, as shown in column 322. Such a combined score may preferably correspond to one or more ranges, such as red, yellow and/or green. Weighting may be formed from subjective subject matter expertise regarding controls.

Such ranges may correspond to various action requirements. For example, when the combined score is found in the red range, immediate remedial action may be called for with respect to the risk and/or control being evaluated. When the combined score is found in the yellow range, the risk and/or control may be put on watch list, whereby the risk and/or control may be evaluated at a higher frequency than with typical risks and/or controls. In the example shown in FIG. 3D, the combined score is equal to 2.85 which places the control in the red zone. As shown in column 324, the comments associated with the risks set forth in column 312 conclude that, “there are inherent risks that are not addressed by a control: i.e., LOB systems and/or LOB external events.”

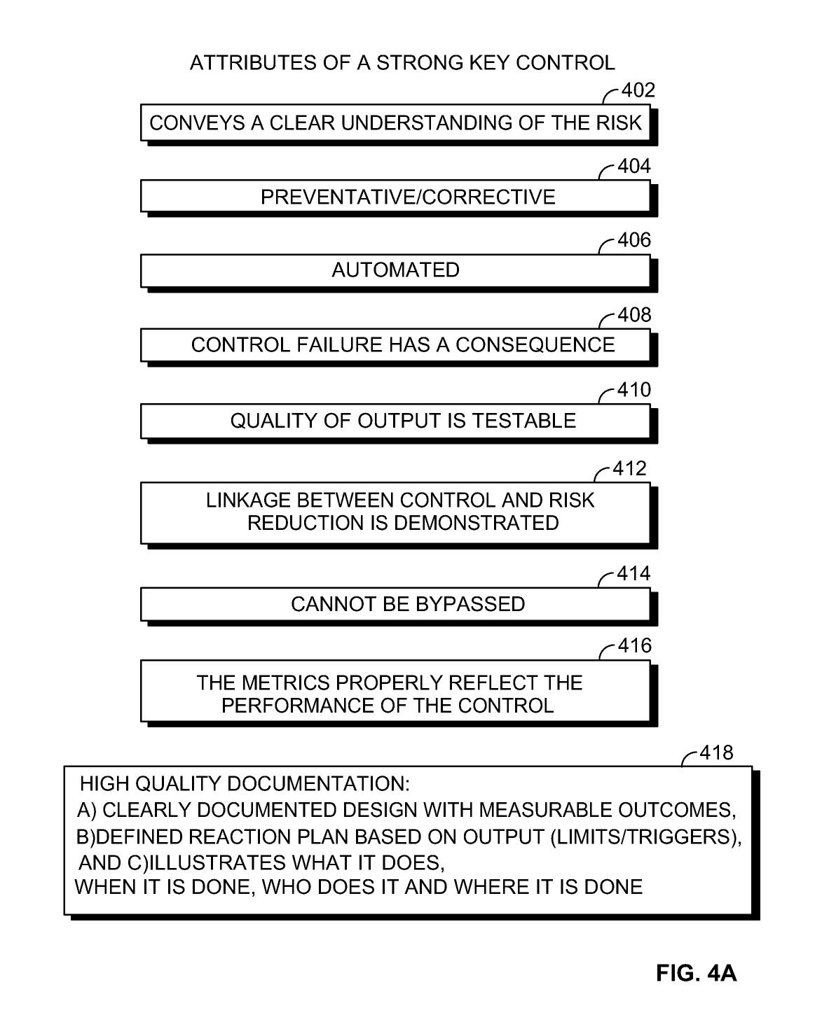

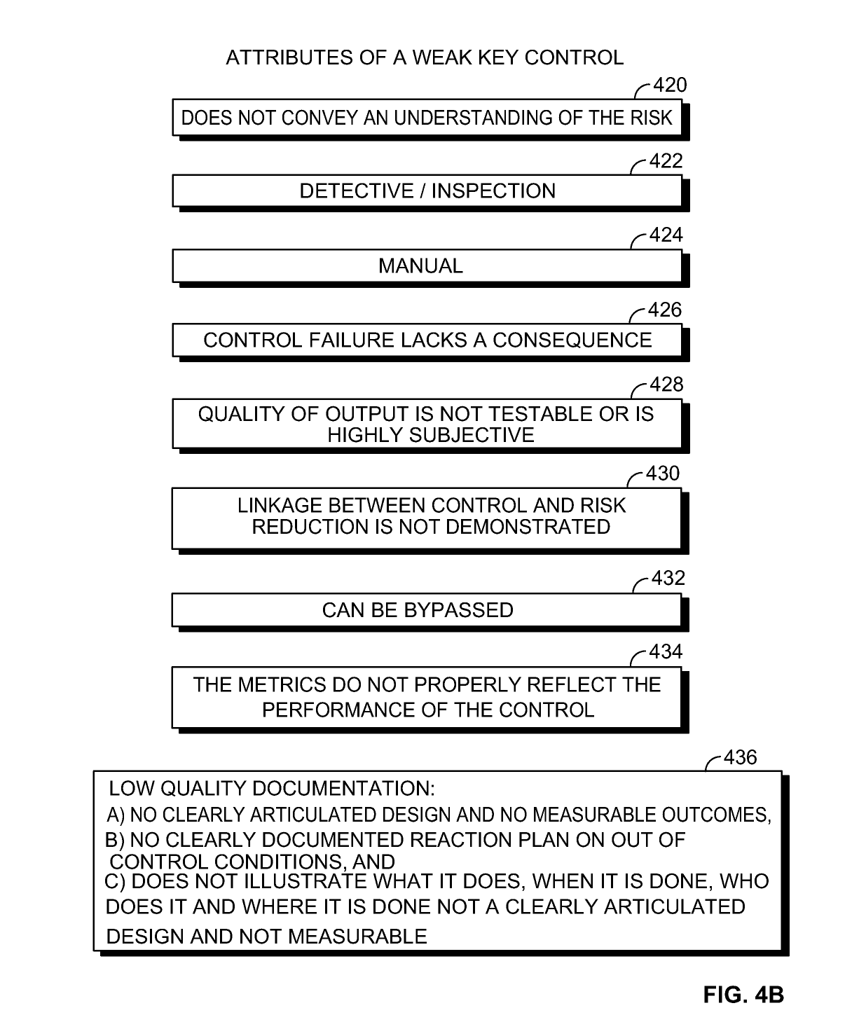

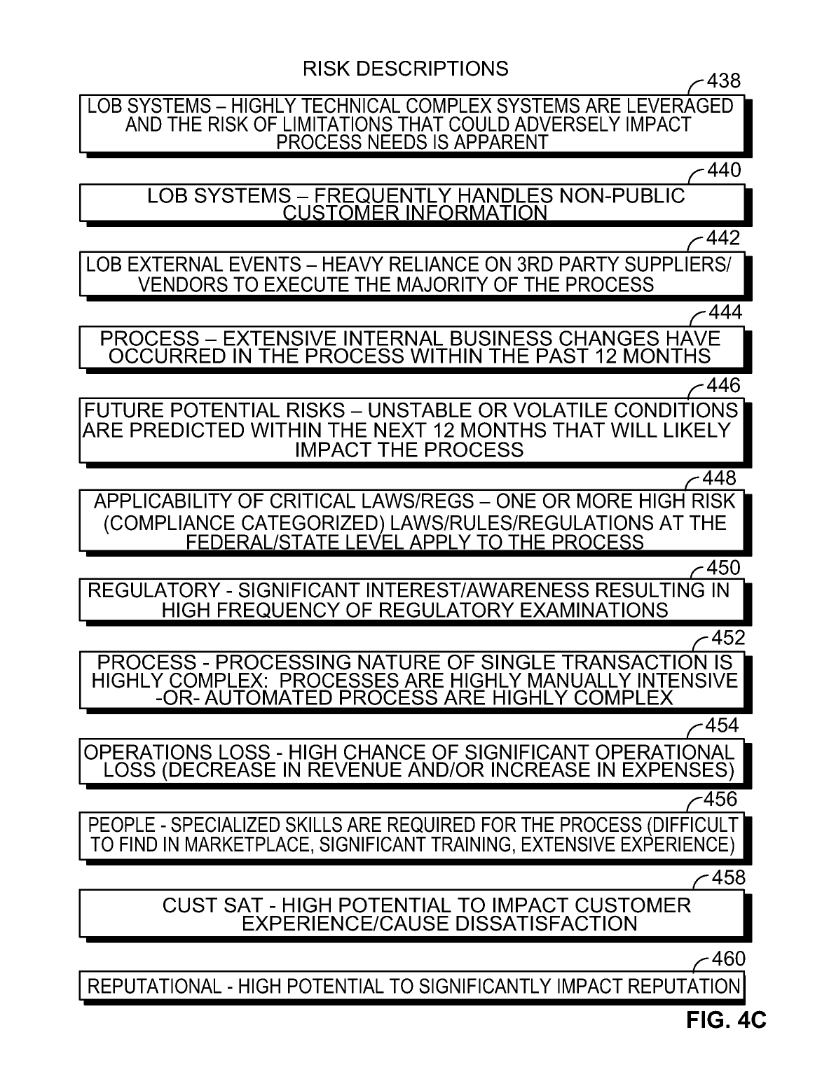

FIGS. 4A-4C show exemplary attributes. FIG. 4A shows exemplary attributes of a relatively strong key control. Such attributes may be understood to correspond to the relatively strong side of the list shown in columns 320 (shown in FIG. 3). Attribute 402 teaches that the control conveys a clear understanding of the risk. Attribute 404 teaches that the control is preventative and/or corrective. Attribute 406 teaches that the control is automated. Attribute 408 teaches that failure of the control leads to a direct consequence. Attribute 410 teaches that the quality of the output is testable. Attribute 412 teaches a linkage between the control and risk reduction is demonstrated. Attribute 414 teaches that the control cannot be bypassed and attribute 416 teaches that the metrics properly reflect the performance of the control.

Attributes shown at 418 include whether the control is associated with relatively high quality documentation. Such documentation may clearly associate the control design with measurable outcomes. The design documentation may define a reaction plan based on limits and/or triggers associated with the implementation of the control, illustrate what the control does, when the control is activated, who (if anyone) performs the control and where the control is implemented.

FIG. 4B shows exemplary attributes of a relatively weak key control. Such attributes may be understood to correspond to the relatively weak side of the list shown in columns 320 (shown in FIG. 3). Attribute 420 teaches that the control does not convey a clear understanding of the risk. Attribute 422 teaches that the control is associated with detecting and/or inspecting for the risk.

Attribute 424 teaches that the control is manually implemented. Attribute 426 teaches that failure of the control lacks a direct consequence. Attribute 428 teaches that the quality of the output is not testable and/or relatively highly subjective.

Attribute 430 teaches a linkage between the control and risk reduction is not demonstrated. Attribute 432 teaches that the control can be bypassed and attribute 434 teaches that the metrics do not properly reflect the performance of the control.

Attributes shown at 436 include whether the control is associated with relatively low quality documentation. Such documentation may not associate the control design with measurable outcomes. The design documentation may fail to define a reaction plan based on limits and/or triggers associated with the implementation of the control, may fail to illustrate what the control does (or fails to do), when the control is active, who (if anyone) performs the control and/or where the control is implemented.

FIG. 4C shows risk descriptions associated with HRPs according to the invention. Risks may include: LOB Systems which are highly technical, complex systems which are leveraged and the risk of limitations that could adversely impact process needs is apparent; LOB systems that frequently handle non-public customer information, 438; LOB external events with heavy reliance on 3^{rd} party suppliers/vendors to execute the majority of the HRP 440; the HRP itself may include extensive internal business changes that have occurred in the process within the past 12 months, 444; unstable or volatile conditions are predicted within the next 12 months that will likely impact the process, 446; one or more high risk laws, rules and/or regulations at the Federal or state level apply to the process, 448; significant interest and/or awareness exists that results in a high frequency of regulatory examinations 450; processing nature of single transaction is highly complex—i.e., processes may be highly manually intensive and/or automated processes are highly complex, 452; a relatively high probability of significant operational loss (which may cause a decrease in revenue and/or an increase in expenses), 454; specialized skills are required for the process, 456; a relatively high potential to impact customer experience/cause dissatisfaction, 458 and/or a high potential to significantly impact reputation, 460.

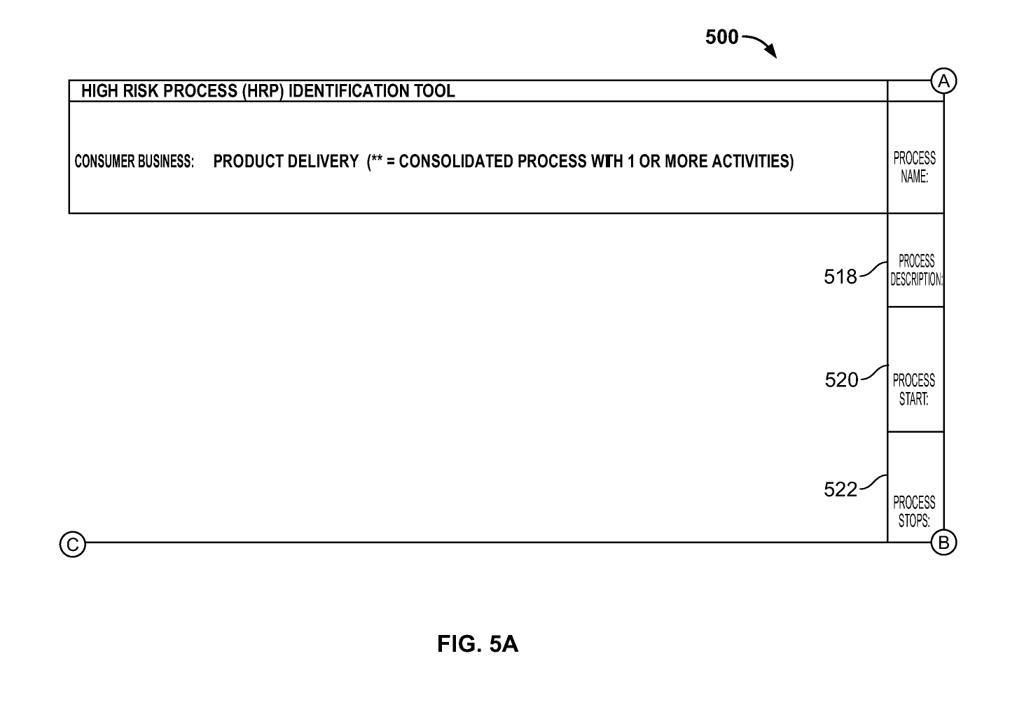

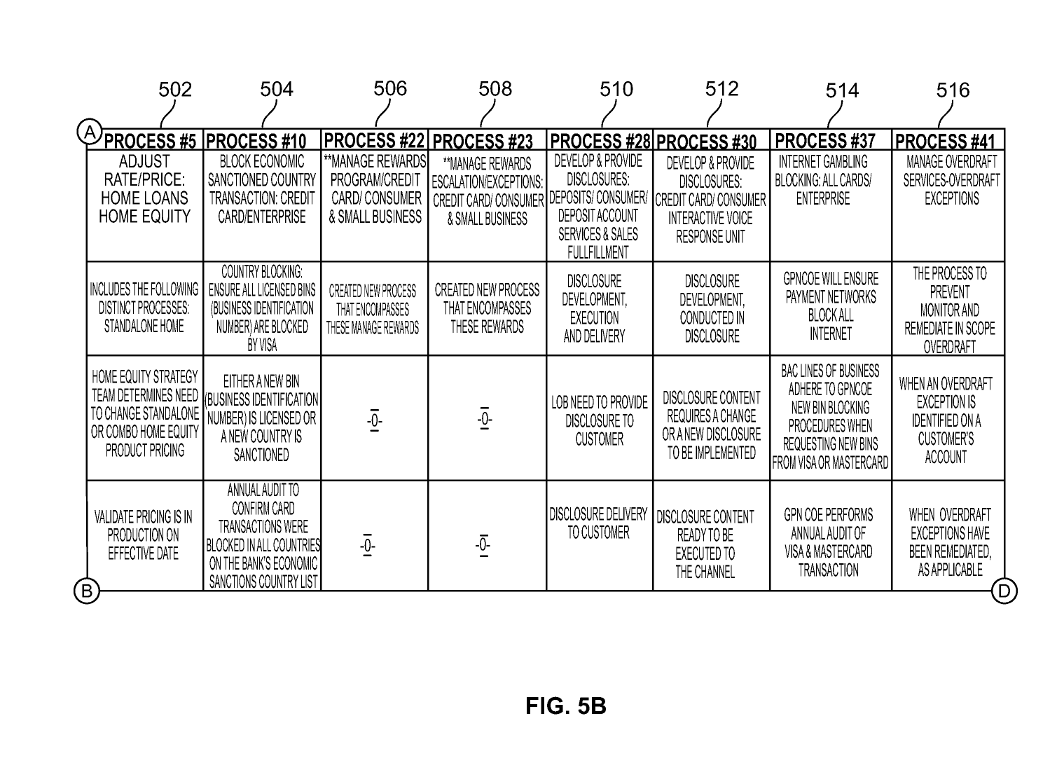

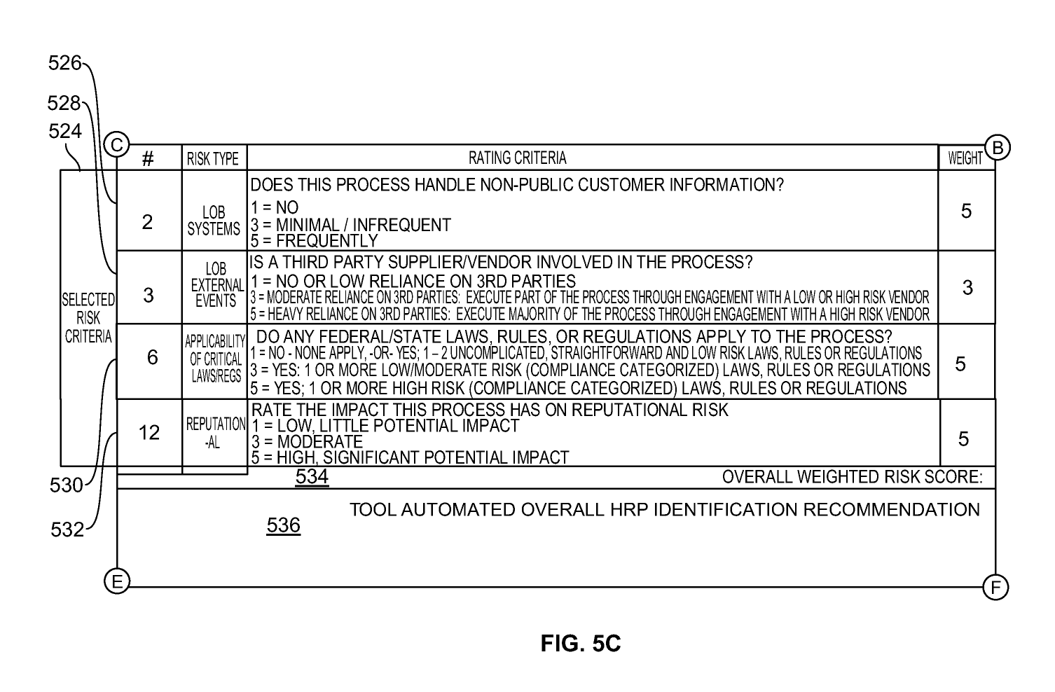

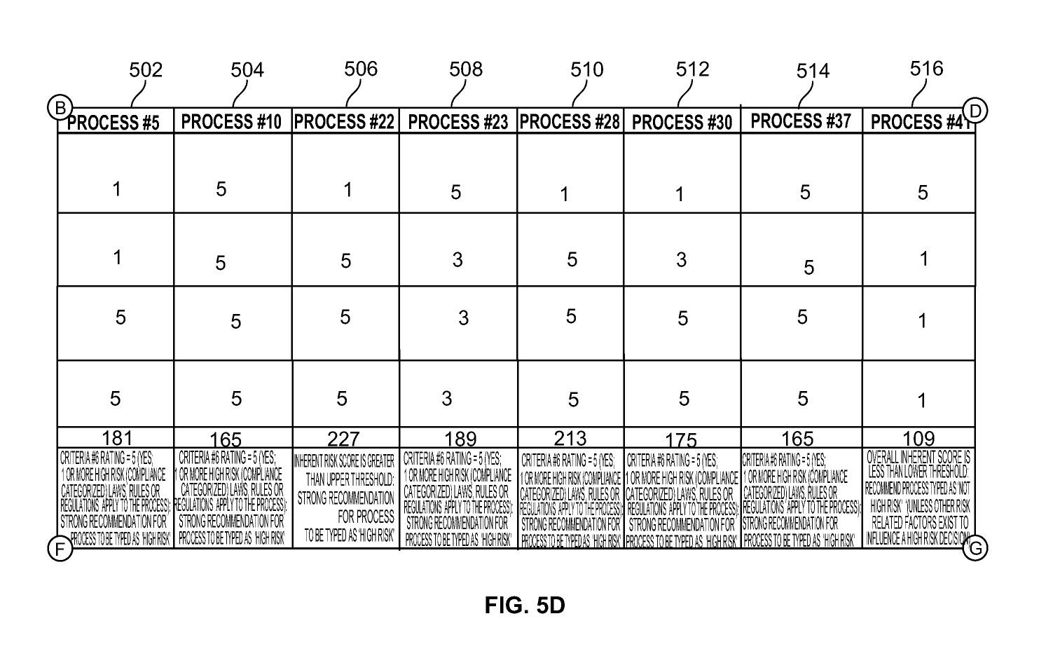

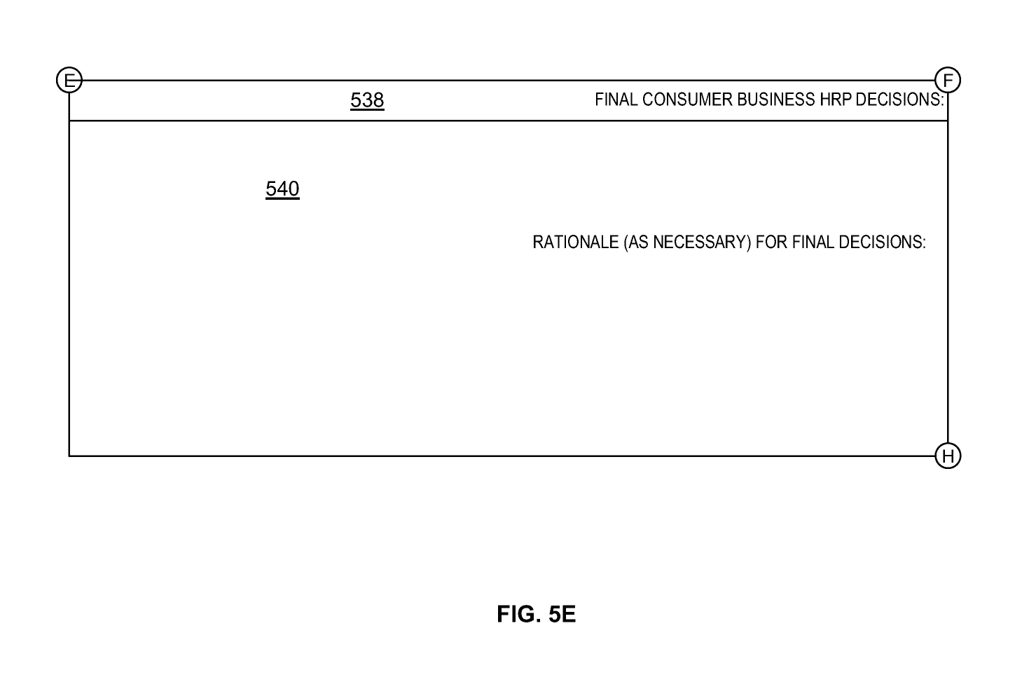

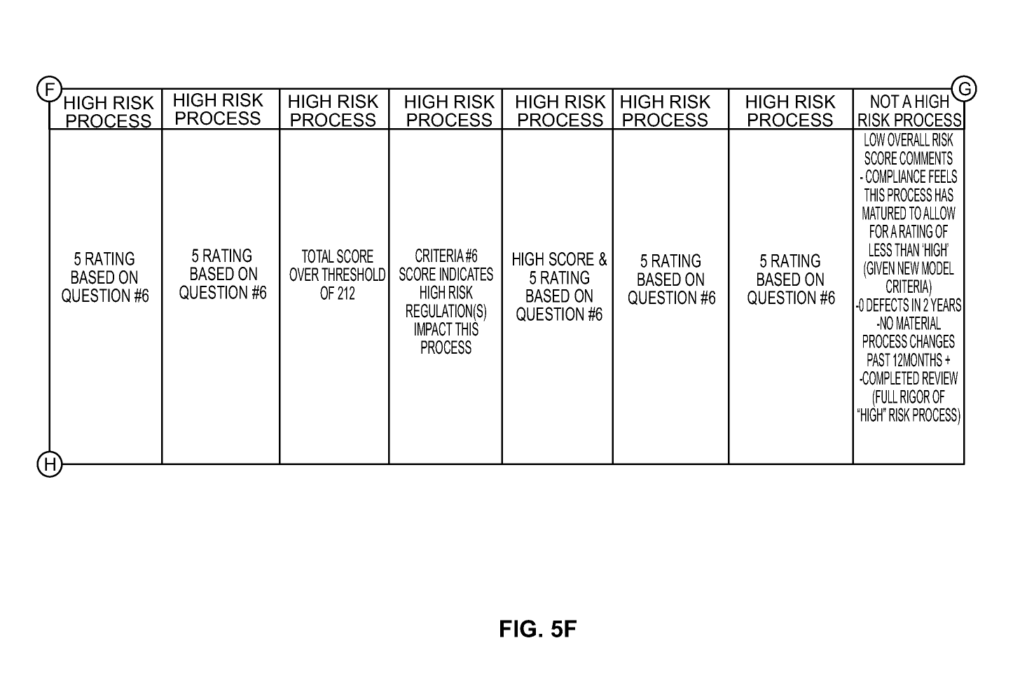

FIGS. 5A-5F show an HRP identification tool 500 which may be used to provide inputs into a tool according to the invention. FIG. 5A shows the left most side of HRP identification tool 500. Row 517 shows the row associated with the product name. Row 518 shows the row associated with the product description. Row 520 corresponds to the process start initiator and row 522 shows the process completion.

FIG. 5B shows several columns that correspond to various processes. Column 502 corresponds to an “adjust rate/price: home loans—home equity” process. As shown further down in column 502, this process relates to a standalone home. As shown further down in column 502, a home equity strategy team may initiate the process by determining that a need exists to change standalone or combo home equity product pricing. Finally, in the bottom cell of the portion of column 502 shown in FIG. 5B, the process ends when the pricing is validated in production on the effective date.

Column 504 shows an additional process relating to blocking economic sanctioned countries' transactions. Column 506 shows an additional process relating to managing rewards program for credit cards, consumers and/or small businesses. Column 508 shows an additional process for managing rewards escalation and/or exceptions for credit cards, consumers and/or small businesses. Column 510 shows an additional process to develop and provide disclosures for deposits, consumers and/or deposit account services and sales fulfillment. Column 512 shows an additional process to develop and provide disclosures for credit card and/or consumer interactive voice response unit. Column 514 shows an additional column relating to internet gambling blocking for all cards and/or an enterprise generally. Column 516 shows an additional column relating to a process for managing overdraft services such as overdraft exceptions.

FIG. 5C shows selected effectiveness criteria 524 in rows 526-532. The effectiveness criteria that appear in columns 526-532 may be used to calculate an overall weighted risk score, as shown in row 534 which, in turn, may be used to obtain an overall HRP identification recommendation, as shown in column 536.

Thus, methods and apparatus for providing a key control assessment tool have been provided. Persons skilled in the art will appreciate that the present invention can be practiced in embodiments other than the described embodiments, which are presented for purposes of illustration rather than of limitation, and that the present invention is limited only by the claims that follow.

What is claimed is:

1. An article of manufacture comprising a non-transitory computer usable medium having computer readable program code embodied therein, the code when executed by one or more processors for configuring a computer to execute a method for determining a degree of alignment between a control element vector and a pre-determined risk factor, the control element vector and the pre-determined risk factor being associated with an entity process, the method comprising:
using a receiver to receive the control element vector;
using a receiver to receive the pre-determined risk factor; and
using a processor to determine a degree of alignment between the control element vector and the pre-determined risk factor.

2. The method of claim 1, wherein the processor is further configured to receive a set of control attributes associated with the control element vector.

3. The method of claim 2, wherein the processor is further configured to receive scores of the attributes.

4. The method of claim 3, wherein the processor is further configured to perform a weighting algorithm on each attribute, such that the algorithm outputs a weighted composite score associated with each of the plurality of control element vectors based, at least in part, on the scores of each of the attributes.

5. The method of claim 2, wherein the set of attributes comprises at least two of the following attributes: the control vector conveys a clear understanding of the risk to which the control vector is directed; failure of the control vector comprises a consequence; the control vector output is testable; a demonstrable linkage exists between the control vector and risk reduction; the control vector can be bypassed; and a set of metrics may be implemented that properly reflects the performance of the control vector.

6. The method of claim 1, wherein the pre-determined risk factor is selected from a group consisting of high level of technical complexity associated with the process; handling, by the entity, of non-public customer information; heavy reliance on third party suppliers/vendors to execute a majority of the process; extensive changes associated with the process implemented over a pre-determined time period; unstable or volatile conditions predicted within a pre-determined time period; one or more high risk laws, rules and/or regulations at the Federal and/or state level apply to the process;
significant interest/awareness resulting in relatively high frequency of regulatory examinations; requires specialized skills; high potential to impact customer experience or to cause dissatisfaction; and high potential to significantly impact reputation.

7. The method of claim 1 further comprising using the receiver to receive plurality of the selected risk factors, wherein a selection of said risk factors is based, at least in part, on the identification of the process.

8. The method of claim 7 further comprising using the processor to determine an index value for each of the risk factors with respect to the process.

9. The method of claim 8 further comprising using the processor to weight the index value for each of the risk factors.

10. The method of claim 9 further comprising using the processor to calculate a composite weighted risk score for the entity process based on the weighting of the index value for each of the risk factors.

11. The method of claim 10 further comprising using the processor to compare the composite weighted risk score to a pre-determined threshold in order to determine whether the process is a high risk process.

12. An article of manufacture comprising a non-transitory computer usable medium having computer readable program code embodied therein, the code when executed by one or more processors for configuring a computer to execute a method for determining a degree of alignment between a control element vector and a pre-determined risk factor, the control element vector and the pre-determined risk factor being associated with an entity process, the method comprising:
using a receiver to receive the control element vector;
using the receiver to receive the pre-determined risk factor; and
using a processor to determine a degree of alignment between the control element vector and the pre-determined risk factor;
wherein the processor is further configured to receive a set of control attributes associated with the control element vector;
wherein the processor is further configured to receive scores of the attributes;
wherein the processor is further configured to perform a weighting algorithm on each attribute, such that the algorithm outputs a weighted composite score associated with each of the plurality of control element vectors based, at least in part, on the scores of each of the attributes.

13. The method of claim 12, wherein the set of attributes comprises at least two of the following attributes: the control vector conveys a clear understanding of the risk to which the control vector is directed; failure of the control vector comprises a consequence; the control vector output is testable; a demonstrable linkage exists between the control vector and risk reduction; the control vector can be bypassed; and a set of metrics may be implemented that properly reflects the performance of the control vector.

14. The method of claim 12, wherein the pre-determined risk factor is selected from a group consisting of high level of technical complexity associated with the process; handling, by the entity, of non-public customer information; heavy reliance on third party suppliers/vendors to execute a majority of the process; extensive changes associated with the process implemented over a pre-determined time period; unstable or volatile conditions predicted within a pre-determined time period; one or more high risk laws, rules and/or regulations at the Federal and/or state level apply to the process;
significant interest/awareness resulting in relatively high frequency of regulatory examinations; requires specialized skills; high potential to impact customer experience or to cause dissatisfaction; and high potential to significantly impact reputation.
